(19) United States
(12) Patent Application Publication
(10) Pub. No.: US 2012/0284363 A1
(43) Pub. Date: Nov. 8, 2012

(54) Method and device for transmitting content

(75) Inventor: Patrick Brown, Cagnes Sur Mer (FR)

(73) Assignee: FRANCE TELECOM, Paris (FR)

(21) Appl. No.: 13/520,036

(22) PCT Filed: Dec. 20, 2010
(86) PCT No.: PCT/FR10/52816

§ 371 Date: Jun. 29, 2012

(30) Foreign Application Priority Data
Dec. 29, 2009 (FR) 0959654

(51) Int. Cl. G06F 15/16

(52) U.S. Cl. 709/217

(57) ABSTRACT

A process and device are provided for transmitting content i by a supplier of this content. The process includes: a step of receiving by the supplier a transmission request of the content i originating from a requester, a step of obtaining by the supplier an estimation Ni of a number of suppliers of the content, and a step of transmitting the content i, during which the supplier sends the requester at least part of the content i by allocating to the requester an average proportion of the bandwidth allocated by this supplier to distribution of content calculated in the form of a coefficient, which is function of the number Ni of suppliers of the content i and of a real value A, common to all the content to be transmitted, serving to adjust the impact on the coefficient of the number Ni of suppliers of the content i.

### CROSS-REFERENCE TO RELATED APPLICATIONS

This Application is a Section 371 National Stage Application of International Application No. PCT/FR2010/052816, filed Dec. 20, 2010, which is incorporated by reference in its entirety and published as WO 2011/080465 on Jul. 7, 2011, not in English.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF THE DISCLOSURE

The present disclosure relates to a process and a device for content transmission. It particularly relates to the field of telecommunications, and more particularly telecommunications over a network, for example the Internet, and that of Internet computer applications such as content distribution ( [symbol] Content Distribution [symbol] ) and peer-to-peer applications or [symbol] P2P [symbol] ( [symbol] peer-to-peer [symbol] in English).

### BACKGROUND OF THE DISCLOSURE

Peer-to-peer file-sharing applications are widely used on the Internet and represent an important part of traffic exchange. Of these applications, file distribution applications of—sharing applications per se can be distinguished. The first of these combine the resources of a large number of peers to download a given file. The best-known example is [symbol] BitTorrent [symbol] (registered trade mark). The second consist of combining a large number of files which form a distributed library. One of the most popular applications of this category is [symbol] eMule [symbol] (registered trade mark). The present disclosure relates mainly to this second category.

File-sharing applications are proposed:
for peer-to-peer content sharing ( [symbol] Content Distribution [symbol] ). The application can be based on a program downloaded at the client terminal or on a program installed in a decoder ( [symbol] Set-top box [symbol] ). The owner of the content can opt for commercial distribution, remunerated per use or by subscription;
as basic principle for exchanges over the Internet of the future. Instead of accessing a file by its URL (acronym for [symbol] Uniform Resource Locator [symbol] to locate uniform resource), as is done today, that is, the address of the file, a file will be identified by a unique code. The file is then downloaded from the terminals of all the web surfers having all or part of the relevant file. The reader could refer to the article by V. Jacobson [symbol] A New Way to Look at Networking [symbol] , August 2006, site of the Google web (http://video.google.com/videoplay?docid=6972678839686672840) and to the European project [symbol] SAIL [symbol] (continuation of the project [symbol] 4WARD [symbol] ) where this network paradigm is described as [symbol] information-centric [symbol] and the network is called [symbol] Network of Information [symbol] (information network).

The application of the content requester is addressed to all or part of the other users owning at least part of the file. At the same time the user requests complementary pieces of the file. The solicited users store the request and reply to it according to service rules defined by the file-sharing application in question. The distribution of a file [symbol] i [symbol] by the terminal of an owner [symbol] P [symbol] is currently done as follows. The owner P queues the requests for files submitted, including in particular requests for file i. These files are also cut up into blocks. P sends each requester blocks belonging to the files requested by this requester.

According to a first family of service rules, the requests can be served as a function of their order of arrival, according to random selection, in parallel, or according to other rules not considering the number of available copies of the file. An example is the [symbol] Round Robin [symbol] discipline service (registered trade mark) in which P in turn sends a block of the requested file to each requester in its file. At any given moment let there be Xi requesters for the file i with an owner P. To the extent where these requests are processed without considering the popularity, and to the extent where these systems comprise a large number of users and Xi varies slowly, it can be considered that, on average, a particular request for a file i receives part 1/(X1+. . . +Xi+. . . ) of the bandwidth which the owner P is keeping for the request. It can be estimated that this result gives an approximate estimation for those rules not taking into account the number of copies of the file, that the files are served as a function of their order of arrival, by following random selection or in parallel.

So, in terms of time taken to obtain a file resulting from the use of this first family of service rules in the sender of the file, performances will obviously depend on the number of copies of this file shared among users of the application. In particular, a less popular file will take longer to download as there are fewer users owning a copy, from which the file can be requested. This effect is leveraged by the fact that a less popular file is stored alongside very popular files by an owner. In this case, the in-demand owner allocates only minor bandwidth to distribution of the less popular file. This delivers performances which can be observed on P2P file-sharing applications showing that the unpopular files are subject to very long downloading times.

A second method of distribution consists of using service rules taking into account the popularity of a file, that is, the number of available copies of the file. By way of example the application [symbol] eMule [symbol] defines popularity thresholds below which the weight of a file is augmented so as to give it preference for being sent. These thresholds are limited in number and the weights are selected heuristically.

At any given moment, let there be a number Xi of requesters for the file i available on the terminal of an owner P. Let [symbol] pi [symbol] be the weight associated with the file i. On average it can be considered that this family of rules allocates to a particular request of a file i a part pi/(p1*X1+. . . +pj*Xj+. . . ) of the bandwidth which the owner P reserves for the application. This mode of sharing is utilised for example with the service discipline [symbol] Weighted Round Robin [symbol] in which requests are dealt with in turn as for [symbol] Round Robin [symbol] but the same request is dealt with a number of times (as a function of the associated weight) before a turn is recommenced. In this respect, the reader could refer to the article by E. Hahne, [symbol] Round Robin scheduling for fair flow control [symbol] , Ph. D. thesis, Dept. Elect. Eng. and Comput. Sci., M.I.T., December 1986.

Another service discipline which omits weight in total value is [symbol] Weighted Fair Queuing [symbol] cited in the following documents:
A. Demers, S. Keshav, S. Shenker, [symbol] Analysis and simulation of a fair queuing algorithm [symbol] , Internet Res. and Exper., vol. 1, 1990,
A. K. Parekh, R. G. Gallager, [symbol] A Generalized Processor-Sharing Approach to Flow Control in Integrated Services Networks [symbol] : The Single-Node Case″, IEEE/ACM Transactions on Networking, Vol. 1, No. 3, June 1993, and
S. J. Golestani, [symbol] A self-clocked fair queuing scheme for high-speed applications [symbol] , proceedings INFOCOM '94, April 1994

However, users of eMule can see that this method fails to find for obtaining a file of the same order for popular and unpopular files. II is actually difficult to select thresholds and weight, knowing that the popularity of a file can vary as a factor of 1 to 100,000.

Existing methods of sharing accordingly deliver very long downloading time for unpopular files, that is, those for which there are few copies.

### SUMMARY

An embodiment of the present invention aims to rectify these disadvantages.

To this effect, according to a first aspect, an embodiment of the present invention specifies a process of transmission of content i by a supplier of this content, characterised in that it comprises:
a receiving step, by said supplier, of a transmission request of the content i originating from a requester,
a step for obtaining, by said supplier, an estimation Ni of a number of suppliers of said content i, and
a transmission step of the content i, during which said supplier transmits to the requester at least part of the content i by allocating to the requester an average proportion of the bandwidth allocated by this supplier to distribution of content calculated in the form of a coefficient, which is function of the number Ni of suppliers of the content i and of a real value A, common to all the content to be transmitted, serving to adjust the impact on said coefficient of the number Ni of suppliers of the content i.

According to a particular embodiment, this coefficient is calculated as a product of the ratio 1/Ni^{A} by a weighting coefficient Wi assigned to the content i, A taking its value in all the real numbers.

Because of these arrangements, it can be decided, by selecting value A which is common to all the content to be transmitted, to favour or not favour the content according to its popularity. In fact, the number Ni represents the number of pairs [symbol] sharing [symbol] the file at a given instant: it is the number of pairs which:
either store the content complete to be transmitted for sharing,
or request the file and have received a complete block of data, forming part of the content to be transmitted, and which is likely to send back such a block to another pair, the block here being the minimal exchange unit used for content transmission.

This value A can actually be used to increase or decrease the distortion between the response time of files having different levels of popularity. As a function of the value of the parameter A, the response times for less popular files can be made as close as preferred to the response times for very popular files. On the contrary, it is possible to increase the response time for the less popular files even more to reduce those times for very popular files. Finally, it is possible to reverse the tendency and to make the response time of less popular files shorter than response time of very popular files.

It therefore becomes possible to attain approximately equal performances in terms of transmission times of same-sized files, irrespective of the number of suppliers, that is, the number of available copies of the content wanted by the requester.

In an embodiment, the average proportion of bandwidth allocated to requesters of the content i is the product of said coefficient by the number Xi of requesters of the content i waiting to be served by said supplier.

It is noted that executing an embodiment of the present invention needs no complex calculating and therefore no consumption of resources on the part of the suppliers of the content.

It is also evident that executing an embodiment of the present invention needs no modification of the information exchange protocol between users. Also, it does not require all users to adopt it for its advantages to be provided, optionally reduced as a function of the number of users not adopting it. An embodiment of the present invention can therefore be deployed progressively on an existing P2P application.

According to an embodiment, the weighting coefficient Wi is equal to Ki * Ei/S, where

S represents a standardisation coefficient of the bandwidth allocated by this supplier to distribution of the content waiting to be served by said supplier,

Ki is a coefficient, a function of a category of content to which the content i belongs,

Ei is a modulation coefficient assigned to the content i, selected such that the ratio between two modulation coefficient values Ei and Ej allocated to two contents i and j to be transmitted is in the interval [0,1; 10].

The sum S aims to standardise the calculated coefficients. Given the adopted notations, this sum is equal to the sum:

K1*E1*X1/N1^{A}+. . . +(Kj*Ej*Xj/Nj^{A})+. . .

where Xj representing the number of requesters of the content j waiting to be served by the relevant supplier, j varying from 1 to jmax, where jmax is the total amount of content waiting to be served by this supplier.

In this sum, the proportion of bandwidth allocated to the requesters of the content j is Kj*Ej*Xj/Nj^{A}.

The coefficient Ki modulates the bandwidth allocated to content so as to for example deliberately favour/disfavour some content, irrespective of their popularity. The highest content of coefficient Ki can be favoured. Inside the same category of content having the same coefficient Ki performances are approximately equal for the same popularity Ni.

The modulation coefficient Ei represents possible variants in the calculation of the coefficient Wi. The coefficient Ei allocated to content i is, for example, a function of Xi and/or of Ni. It has been observed that a value of Ei equal to 1 for all content i is optimal, but that variations around this optimal value are possible without substantially degrading performances obtained with this optimal value.

According to particular characteristics, the step of obtaining the estimation Ni comprises:
an emission step, by said supplier, of an availability declaration request of the content i intended for third-party users potentially suppliers of the content i,
a receiving step of responses on the part of third-party users potentially suppliers of the content i, and
a processing step of responses for determining the estimation Ni of the number of suppliers of said content.

Because of these arrangements and because of a fictitious request of the content i, the number Ni, the supplier autonomously determines that other users, including the requester, are using or not using the process forming the subject matter of an embodiment of the present invention.

According to particular characteristics, the step of obtaining the estimation Ni comprises a step for determining whether the estimation Ni has already been obtained by the supplier during a predetermined elapsed period and, only if the estimation Ni has not already been obtained, the emission step of the request intended for third-party users, the receiving step of responses on the part of third-party users and the processing step.

This avoids any risk of congestion of the network due to fictitious requests sent by suppliers to find out the estimation Ni of the number of suppliers of the content.

According to particular characteristics, the step of obtaining the estimation Ni comprises:
an emission step, by the requester, of an availability declaration request of the content i intended for users potentially suppliers of the content i,
a receiving step of responses on the part of users potentially suppliers of the content i,
a processing step of responses for determining the estimation Ni of the number of suppliers of said content, and
a transmission step of the estimation Ni by the requester intended for at least one supplier.

Because of these arrangements, the process forming the subject matter of an embodiment of the present invention does not utilise a supplementary request, relative to those processes known from the prior art.

According to particular characteristics, during the transmission step, at least one supplier transmits at least part of the content i by allocating a decreasing bandwidth function of the estimation Ni of the number of suppliers.

According to particular characteristics, during the transmission step, at least one supplier transmits at least part of the content i by allocating a bandwidth in average proportion of (1/Ni^{A})/(X1/N1^{A}+. . . +Xj/Nj^{A}+. . . ) of the bandwidth allocated by this supplier to distribution of peer-to-peer content.

It is noted that the application implementing the process forming the subject matter of an embodiment of the present invention can be parametered so as to increase or decrease distortion between the response time of files of different levels of popularity. As a function of the value of the parameter A, the response time for the less popular files can be made as close as wanted to the response time for very popular files. On the contrary, it is possible to increase further still the response times for less popular files to then reduce those for very popular files. Finally, it is possible to reverse the tendency and make the response times of less popular files shorter than the response times of very popular files.

The possibility of modulating the distortions of response times is important to adapt to the aims fixed during distribution of files, aims which depend on the context. For example, if the aim is to distribute new content rapidly the value of the parameter A is fixed so that the less popular content benefits from particularly short response times. On the contrary, the aim can be to parameterise the system so as to reinforce the advantage from which popular content naturally benefits.

If the value of A is positive, the less popular files see their response times diminish and all the more as the value of A increases. If the value of A is negative, it is the popular files which see their response times diminish (to the detriment of less popular files) and all the more as the absolute value of A increases. The particular case of A=1 produces response times almost independent of the popularity. If A>1 is selected, the result is response times for the less popular files which are shorter than the response time of popular files.

According to particular characteristics, during the transmission step, at least one supplier transmits at least part of the content i by allocating a bandwidth function also of the content to be transmitted.

In this way the files comprising the biggest quantities of information can be favoured, or on the contrary, the smallest, the content being texts, images, sounds, music or videos, for example.

According to particular characteristics, during the step for requesting content i, the requester user transmits an availability declaration request to potential suppliers.

According to particular characteristics, during the step for requesting content i, the requester user transmits an availability declaration request to at least one server which centralises the content available from potential suppliers.

An embodiment of the present invention applies to file-sharing applications stored on servers for finding the owners of files.

According to particular characteristics, during the step for requesting content i, the requester user transmits an availability declaration request to other users who send on said request.

An embodiment of the present invention applies to file-sharing applications stored on file-search systems from one person to another, such as for example the applications Gnutella (registered trade mark) and eMule when the latter is based on the distributed application Kademlia (registered trade mark).

According to a second aspect, an embodiment of the present invention specifies a content transmission device which comprises:
means for receiving, by said supplier, a transmission request of the content i originating from a requester,
means for obtaining, by said supplier, an estimation Ni of the number of suppliers of said content, and
means for transmission of the content i adapted to be transmitted to the requester at least part of the content i by allocating to the requester an average proportion of the bandwidth allocated by this supplier to distribution of content calculated in the form of a coefficient, which is a function of the number Ni of suppliers of the content i and of a real value A, common to all the content to be transmitted, serving to adjust the impact on said coefficient of the number Ni of suppliers of the content i.

According to a third aspect, an embodiment of the present invention specifies a computer program loadable into a computer system, said program containing instructions for executing the process forming the subject of an embodiment of the present invention, such as succinctly explained hereinabove.

According to a fourth aspect, an embodiment of the present invention specifies a data-storage medium readable by a computer or a microprocessor, removable or not, containing instructions of a computer program, characterised in that it executes the process forming the subject of an embodiment of the present invention, such as succinctly explained hereinabove.

Since the advantages, aims and characteristics of this device, this computer program and this data-storage medium are similar to those of the process forming the subject of an embodiment of the present invention, such as succinctly explained hereinabove, they are not repeated here.

### BRIEF DESCRIPTION OF THE DRAWINGS

Other advantages, aims and characteristics will emerge from the following description given by way of explication and non-limiting with respect to the attached diagrams, in which:

FIG. 1 illustrates schematically users of a content-sharing application,

FIG. 2 illustrates schematically files available from users of the content-sharing application,

FIG. 3 illustrates schematically a particular embodiment of a device forming the subject of the present invention,

FIG. 4 illustrates in the form of a logigram steps taken in a first particular embodiment of the process forming the subject of the present invention, and

FIG. 5 illustrates in the form of a logigram steps taken in a second embodiment particular of the process forming the subject of the present invention.

### DETAILED DESCRIPTION OF ILLUSTRATIVE EMBODIMENTS

Throughout the description, [symbol] user [symbol] or [symbol] peer [symbol] refers to a terminal with means of running a content-sharing application, especially for downloading content over a network. For example, these are personal computers fitted with a modem or an Internet connection box and adequate programs, some of which are cited hereinabove.

FIG. 1 shows five users or [symbol] peers [symbol] 115 to 130 connected to a communications network 105 and using file-sharing applications. The communications network 105 is, for example, the Internet. At least one user is running a computer program (not shown) loadable into a computer system, said program containing instructions for executing the process forming the subject of an embodiment of the present invention, such as described hereinbelow. This program is stored on a data-storage medium (not shown) readable by a computer or a microprocessor, removable or not, containing instructions of this program, for example, a hard drive, a flash drive or a compact disc.

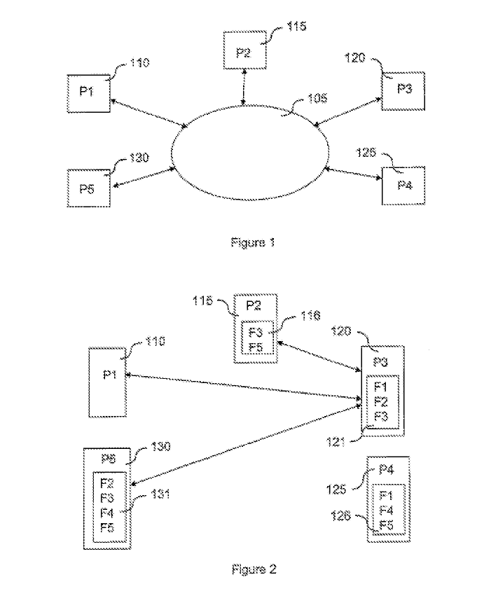

FIG. 2 shows the users 115 to 130. FIG. 2 also shows files available from users 115, files 116, 120, files 121, 125, files 126 and 130, files 131. In FIG. 2 the user 110 and the user 130 are requesting the user 120 to send them blocks of data composing the file F1 and the user 115 is requesting the user 120 to send him blocks of data composing the file F2.

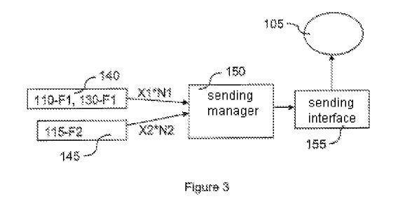

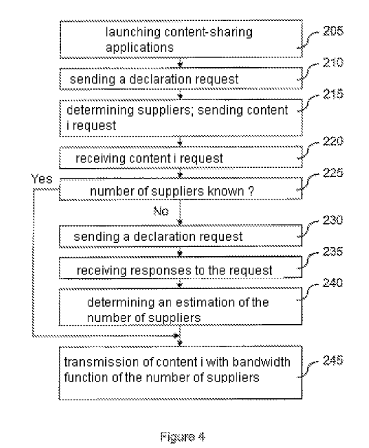

FIG. 3 illustrates the wait files system for sending to the user 120. As in FIG. 2, the users 110 and 130 have requested the file F1 from the user 120, whereas the user 115 has requested the file F2 from the user 120.

In this embodiment there is one file per folder. The first file 140 relates to the file F1 and the second file 145 relates to the file F2. The first file 140 therefore comprises blocks of the file F1 to be transmitted to the user 110 and blocks of the file F1 to be transmitted to the user 130. The second file 145 comprises blocks of the file F2 to be transmitted to the user 115. A data block sending manager 150 deals with the wait files, that is, draws data blocks of files to be transmitted, and transmits these data over the network 105, by means of an emission interface 155. For example, the sending manager 150 is a server of [symbol] Weighted Fair Queuing [symbol] (adjusted queuing) or [symbol] Weighted Round Robin [symbol] type.

The files are preferably served, by the block sending manager 150, at average proportion calculated as a product of the ratio 1/Ni^{A} by a weighting coefficient Wi assigned to the content i, A taking its value in all the real numbers, and Ni being an estimation of the number of suppliers of the content i.

According to an embodiment, the standardisation coefficient Wi is equal to Ki * Ei/S, where
S represents a standardisation coefficient of the total bandwidth allocated by this distribution supplier to content waiting to be served by said supplier,
Ki is a coefficient, a function of a category of content to which the content i belongs,
Ei is a modulation coefficient assigned to the content i, selected such that the ratio between two modulation coefficient values Ei and Ej allocated to two contents i and j to be transmitted is in the interval [0,1; 10].

The sum S aims to standardise the calculated coefficients. Given the adopted notations, this sum is equal to the sum:

K1*E1*X1/N1^{A}+. . . +(Kj*Ej*Xj/Nj^{A})+. . .

The coefficient Ki modulates the bandwidth allocated to content i, for example to deliberately favour/disfavour some content, irrespective of its popularity. The highest coefficient content Ki could be favoured as follows: it can be content having particular importance for which rapid transmission is needed. When some content is not to be favoured, the coefficient Ki will be selected equal to 1 for all content i.

The modulation coefficients Ei are preferably such that the ratio between any two values of modulation coefficients Ei and Ej allocated to two contents i and j is between 0.1 and 10, preferably between 0.2 and 5. More preferably, this ratio takes its values between 0.3 and 3. Even more preferably, this ratio takes its values between 0.5 and 2.

For example, the coefficient Ei allocated to content i is a function of Xi and/or of Ni.

A value of Ei and Ki equal to 1 for all content gives optimal results from the point of view of equity.

So, the user 120 who is acting here as content supplier, transmits at least part of the content requested by each requester user by allocating a bandwidth function of the estimated number of suppliers for this content. The bandwidth attributed to each content is preferably a decreasing function of the estimated number of suppliers of this content.

In the embodiment described in FIG. 3, the file 140 is served with a weight of twice (as there are two requesters) the number of suppliers of the file F1 and the file 145 is served with a weight of once (single requester only) the number of suppliers of the file F2.

In particular embodiments of the present invention, the coefficients Ki and Ei are selected equal to 1, at least one supplier transmits at least part of the content i by allocating a bandwidth of average proportion of (1/Ni^{A})/(X1/N1^{A}+. . . +Xj/Nj^{A}+. . . ) of the bandwidth allocated by this supplier to distribution of peer-to-peer content.

In particular embodiments of the present invention, at least one supplier transmits at least part of the content i by allocating a bandwidth function, also, of the content to be transmitted.

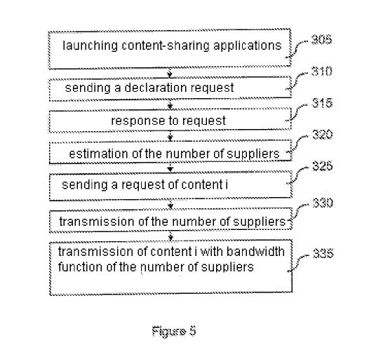

The principal steps of a first particular embodiment of the process forming the subject matter of the invention are shown in FIG. 4.

During a step 205, each user participating in content exchange launches a content-sharing application and allocates bandwidth to this application.

During a step 210, a requester sends an availability declaration request of content i by identifying this content i, intended for at least one server which centralises the information of the number of copies of each content, intended for other users who relay this request from one to the other or, especially in the case of small networks, intended for other users. This request serves to find out identifiers of users owning the content i, also called [symbol] potential suppliers [symbol] . Once the responses are obtained, during a step 215 the requester sends a transmission request of at least part of the content i intended for potential suppliers. At the same time, the supplier who implements steps 225 to 245 receives this request and extracts from it the identifier of the content i during a step 220.

During a step 225, this user determines whether it has already obtained an estimation Ni of the number of potential suppliers of the content i during a predetermined elapsed time period, for example during the last minute elapsed. The interest of this step 225 is explained at the end of the description of FIG. 4. If he has already determined this estimation Ni, this user moves on to step 245.

If not, during a step 230 this user sends an availability declaration request of the content i by identifying this content i, similarly as for step 210. This request is in fact fictitious since this user is not trying to obtain transmission of the content i but only to estimate or find out the number of other suppliers of the content i.

According to content-sharing applications, during each step 210 and 230 for request of the content i, the request is transmitted:
to potential suppliers,
to a server which centralises the content available from potential suppliers and/or
to other users who send on said request.

During a step 235, those users having the content i respond to requests sent during step 230 by identifying themselves as potential suppliers of the content i. In particular, the supplier implementing steps 220 to 245 receives these responses.

During a step 240, this user, who will be supplier of the content i vis-à-vis the requester who has sent a request during step 210, processes the responses obtained to his request and determines an estimation Ni of the number of potential suppliers of the content i, including himself. This estimation is preferably the exact number of suppliers of the content i.

For this estimation the reader could refer to the article by Patrick Brown and Sanja Petrovic [symbol] A New Statistical Approach to Estimate Global File Populations in the eDonkey P2P File-Sharing System [symbol] , in ITC21, 21st International Teletraffic Congress, 2009.

During a step 245, the supplier transmits at least part of the content i by allocating a bandwidth function of the estimation Ni of the number of suppliers.

During step 245 at least one supplier preferably transmits at least part of the content i by allocating a bandwidth function decreasing of the estimation Ni of the number of suppliers.

As is evident, step 225 prevents requests from multiplying because, without this step 225, each request received by a supplier would cause sending of a request which in turn would cause another, resulting in congestion of the network.

In embodiments, during step 245, at least one supplier transmits at least part of the content i by allocating a bandwidth of average proportion calculated as a product of the ratio 1/Ni^{A} by a weighting coefficient Wi assigned to the content i, A taking its value in all the real numbers, and Ni being an estimation of the number of suppliers of the content i.

In embodiments, during step 245, at least one supplier transmits at least part of the content i by allocating a bandwidth of average proportion of (1/Ni^{A})/(X1/N1^{A}+. . . +Xj/Nj^{A}+. . . ) of the bandwidth allocated by this supplier to distribution of peer-to-peer content, A taking its value in all the real numbers, Xj representing the number of requesters of the content j waiting to be served by said supplier.

In embodiments, during step 245, at least one supplier transmits at least part of the content i by allocating a bandwidth function, also, of the content i. These embodiments combine with the processes for favouring some files relative to others as a function of their content. For this, the weight 1/Ni^{A} can be multiplied by the weighting coefficients Wi linked to the preference to be allocated to such or such content.

A first variant consists of the user supplier serving a requester of a file i in his possession in proportion (1/Ni)/(X1/N1+. . . +Xj/Nj+. . . ) with the bandwidth allocated to distribution of files. Execution in a particular realisation can employ [symbol] Weighted Fair Queuing [symbol] or [symbol] Weighted Round Robin [symbol] service disciplines. To the extent where this proportion must be obtained on average other disciplines can be utilised. For example, the request to be served can be randomly drawn with a weight 1/Ni, transfer a block corresponding to the drawn request then repeat drawing, etc.

Digital analysis shows that when all participating users apply such a procedure, the performances in terms of transmission times of same-sized content are almost identical irrespective of the popularity, that is, the number of copies, of this content.

Execution of the embodiment of the invention illustrated in FIG. 4 needs no modification of the file distribution mechanism in its entirety. Only exchanges of existing messages in any application of this type are used. Also, each user can execute the process forming the subject of an embodiment of the present invention independently of other users. It is unnecessary for any software upgrade of all sharing applications to be carried out, or for synchronous switching on the all users to this update.

In particular an embodiment of the invention can be executed even if users belong to different and uncoordinated administrative entities.

An embodiment of the invention also arbitrarily modulates the response times as a function the popularity.

If there is interest in the function (1/Ni^{A})/(X1/N1^{A}+. . . +Xj/Nj^{A}+. . . ), in the embodiments of the process forming the subject of the present invention in which the user supplier serves a requester of a file i in his possession in proportion to this function of the bandwidth which he allocates to file distribution:
if A were zero, performances would be the same as if there were no consideration of the number of content suppliers, which is excluded here,
if A is positive, the less popular files see their response times decrease and all the more since A increases,
if A>1, response times for the less popular files are obtained which are shorter than the response times of popular files. The inequalities in performance in this case swing in favour of less popular files, and
if A is negative, it is the popular files which see their response times decrease (to the detriment of less popular files) and all the more since the absolute value of A rises.

It is noted that the particular case of A=1, producing response times almost independent of popularity, is illustrated in FIG. 3.

The principal steps of a second particular embodiment of the process forming the subject matter of the invention are illustrated in FIG. 5.

During a step 305, each user participating in content exchange launches a content-sharing application and allocates bandwidth to this application.

During a step 310, a requester sends an availability declaration request of content i by identifying this content i, intended for at least one server which centralises the information of the number of copies of each content, intended for other users who relay this request from one to another or, especially in the case of small networks, intended for other users. This request serves to find out identifiers of users owning the content i, also called [symbol] potential suppliers [symbol] .

During a step 315, the users who have the content i respond to the request by identifying themselves as potential suppliers of the content i.

During a step 320, the requester user processes the responses obtained on the part of the supplier users for determining an estimation Ni of the number of suppliers of the content i.

During a step 325, the requester user transmits to some of the potential suppliers a transmission request of the content i. During a step 330, the requester transmits, at least to each selected supplier implementing an embodiment of the present invention, the estimation Ni of the number of suppliers of the content i. It is noted that, in the case illustrated in FIG. 5, this estimation Ni is preferably the exact number of suppliers to whom the request of the step 325 is addressed.

During a step 335, at least one supplier transmits at least part of the content i in allocating a bandwidth function of the estimation Ni of the number of suppliers, similarly to what is described with respect to step 245.

1. A process for transmission of content i by a supplier of this content, wherein the process comprises:
receiving by said supplier a transmission request of the content i originating from a requester,
obtaining by said supplier an estimation Ni of a number of suppliers of said content, and
transmitting the content i, during which said supplier transmits to the requester at least part of the content i by allocating to the requester an average proportion of bandwidth allocated by this supplier to distribution of content calculated in the form of a coefficient, which is function of the number Ni of suppliers of the content i and of a real value A, common to all the content to be transmitted, serving to adjust an impact on said coefficient of the number Ni of suppliers of the content i.

2. The process as claimed in claim 1, in which said coefficient is calculated as a product of a ratio 1/Ni^{A} by a weighting coefficient Wi assigned to the content i, A taking its value in all the real numbers.

3. The process as claimed in claim 1, in which the average proportion of bandwidth allocated to the requesters of the content i is the product of said coefficient by the number Xi of requesters of the content i waiting to be served by said supplier.

4. The process as claimed in claim 2, in which the weighting coefficient Wi is equal to Ki * Ei/S, where
S represents a standardisation coefficient,
Ki is a coefficient function of a category of content to which the content i belongs, and
Ei is a modulation coefficient assigned to the content i, selected such that the ratio between two modulation coefficient values Ei and Ej allocated to two contents i and j to be transmitted is in the interval [0,1; 10].

5. The process as claimed in claim 4, in which the standardisation coefficient S is equal to the sum:
K1*E1*X1/N1^{A}+. . . +(Kj*Ej*Xj/Nj^{A})+. . .
where Xj represents the number of requesters of the content j waiting to be served by said supplier.

6. The process as claimed in claim 4, in which the coefficient Ei allocated to content i is a function of Xi and/or Ni, where:
Xi represents the number of requesters of the content i waiting to be served by said supplier.

7. The process as claimed in claim 1, in which obtaining the estimation Ni comprises:
emitting by said supplier of an availability declaration request of the content i intended for third-party users potentially suppliers of the content i,
receiving responses on the part of third-party users potentially suppliers of the content i, and
processing responses for determining an estimation Ni of the number of suppliers of said content.

8. The process as claimed in claim 7, in which obtaining the estimation Ni comprises determining if the estimation Ni has already been obtained by the supplier during a predetermined elapsed period and, only if the estimation Ni has not already been obtained, the emitting of the request intended for the third-party users, the receiving responses on the part of third-party users and the processing step.

9. The process as claimed in claim 1, in which obtaining the estimation Ni comprises:
emitting by the requester of a availability declaration request of the content i intended for users potentially suppliers of the content i,
receiving responses on the part of users potentially suppliers of the content i,
processing responses for determining an estimation Ni of the number of suppliers of said content, and
transmitting the estimation Ni, by the requester intended for at least one supplier.

10. The process as claimed in claim 1, in which, during the transmitting, at least one supplier transmits at least part of the content i by allocating a decreasing bandwidth function of the estimation Ni of the number of suppliers.

11. The process as claimed in claim 1, in which, during the transmitting, at least one supplier transmits at least part of the content i by allocating bandwidth of average proportion of (1/Ni^{A})/(X1/N1^{A}+. . . +Xj/Nj^{A}+. . . ) of the bandwidth allocated by this supplier to distribution of peer-to-peer content.

12. A device for transmission of content i by a supplier of this content, wherein the device comprises:
means for receiving by said supplier a transmission request of the content i originating from a requester,
means for obtaining by said supplier an estimation Ni of the number of suppliers of said content, and
means for transmission of the content i adapted to transmit to the requester at least part of the content i by allocating to the requester an average proportion of bandwidth allocated by this supplier to the distribution of content calculated in the form of a coefficient, which is function of the number Ni of suppliers of the content i and of a real value A, common to all the contents to be transmitted, serving to adjust an impact on said coefficient of the number Ni of suppliers of the content i.

13. The device as claimed in claim 1, comprising means for calculating said coefficient as product of the ratio 1/Ni^{A} by a weighting coefficient Wi assigned to the content i, A taking its value in all the real numbers.

14. (canceled)

15. A non-transitory information media readable by a computer or a microprocessor, removable or non, and containing instructions of a computer program, wherein the instructions are configured to execute a process of transmitting content i by a supplier of this content, wherein the process comprises:
receiving by said supplier a transmission request of the content i originating from a requester,
obtaining by said supplier an estimation Ni of a number of suppliers of said content, and
transmitting the content i, during which said supplier transmits to the requester at least part of the content i by allocating to the requester an average proportion of bandwidth allocated by this supplier to distribution of content calculated in the form of a coefficient, which is function of the number Ni of suppliers of the content i and of a real value A, common to all the content to be transmitted, serving to adjust an impact on said coefficient of the number Ni of suppliers of the content i.
